(19) United States
(12) Patent Application Publication
(10) Pub. No.: US 2012/0182427 A1
(43) Pub. Date: Jul. 19, 2012

(54) SYSTEM AND METHOD FOR PROVIDING THERMAL GENDER RECOGNITION

(76) Inventor: Aaron Marshall, Valley Village, CA (US)

(21) Appl. No.: 13/154,276

(22) Filed: Jun. 6, 2011

(51) Int. Cl. H04N 7/18

(52) U.S. Cl. 348/159; 348/E05.09

(57) ABSTRACT

A system and method for providing thermal gender recognition of people in any place of entertainment, leisure and/or recreation. The system utilizes infrared thermal imaging cameras and enables a prospective attendee determine in advance from a remote location where the prospective attendee would like to be. The system includes at least one computer system capable of communicating with a server over a network for retrieval, processing, and transmission of captured image data of each person in view of the infrared thermal imaging cameras. A website is configured to receive the image data of each person from the at least one computer system and implement the image data in a suitable format for viewing of the icons in various locations of the place by the prospective attendee from the remote location.

### TECHNICAL FIELD

The present invention relates to the field of gender identification, and more specifically, to a system and method for providing thermal gender recognition of people in any place of entertainment, leisure, and/or recreation, to enable prospective attendees determine in advance from a remote location where they would like to be.

### BACKGROUND OF THE INVENTION

Conventional gender identification systems and methods have been used primarily for marketing, surveillance, or other such practical purposes. As marketing is the driving force behind gender identification systems, marketing and other such companies have bypassed thermal recognition in favor of facial recognition. Facial recognition enables companies to see an individual's gender, race, and approximate age group, thus, far surpassing thermal capabilities for marketing purposes. While use of facial recognition systems may be advantageous for marketing, surveillance, and the like, society may view facial recognition as intrusive of a person's privacy in that such type of recognition requires a person to look toward the camera.

With infrared light or thermography, an infrared imaging and measurement camera is used to see and measure thermal energy emitted from an individual or object hence a person's face is not revealed. Thermal or infrared energy is invisible to the human eye due to its long wavelength, the part of the electromagnetic spectrum (approximately 8-15 μm) that is perceived as heat. In particular, an infrared camera is used to detect infrared energy (i.e., heat) and converts the energy into an electronic signal, which is processed to produce a thermal image (i.e., thermograms) on a video screen or monitor and perform temperature calculations. Thermal imaging systems are in widespread use and have many applications from condition monitoring, manufacturing process control, medical science, predictive maintenance, research and development, temperature measurement and thermal testing to law enforcement, security, and surveillance.

Today, the global population has ever increasing demands on their already busy lifestyles such that when people have the time to engage in entertainment, leisure, and/or recreational activities, these persons are unable to determine in advance what the particular entertainment, leisure, and recreational place will be like without spending valuable time traveling to the place and seeing for themselves the environment firsthand. It would be desirable to have a gender identification system and method for using less invasive thermal imaging that would enable potential attendees of any place of entertainment, leisure, and/or recreation to determine from their respective remote locations prior to going to the particular establishment, event, lounge, night club, restaurant, and the like, where they would like to be based on the number of total attendees, gender (male to female/female to male) ratio, etc., among other desirable features, as described herein.

### SUMMARY OF THE INVENTION

In a first aspect, there is provided herein a system for providing thermal gender recognition of people in any place of entertainment, leisure and/or recreation, to enable a prospective attendee determine in advance from a remote location where the prospective attendee would like to be. The system includes a first infrared thermal imaging camera positioned in a first location of the place for capturing image data of people passing therethrough by which a body temperature of each person is obtained for calculating a person's gender, wherein the first infrared thermal imaging camera thereby assigns an image signature to each person. A people counter system is configured to be implemented in conjunction with the first infrared thermal imaging camera for concurrently counting each gender passing through the first location. A second infrared thermal imaging camera having at least one microphone is positioned in a second location of the place and is configured to continue gender recognition and follow each person in view while showing movement and/or position of such persons in the form of a representative icon for each gender against a corresponding still photograph background of the second location for viewing movement and/or position of the icons in the second location. At least one optional infrared thermal imaging camera is positioned in at least one additional location and is configured to continue gender recognition and follow each person in view while showing movement and/or position of the icons for each gender against a corresponding optional still photograph background of the at least one additional location for viewing movement and/or position of the icons in the at least one additional location.

The system further includes at least one computer system capable of communicating with a server over a network for retrieval, processing, and transmission of the image data of each person in view of the first and second infrared thermal imaging cameras and the at least one optional infrared thermal imaging camera. A website is configured to receive the image data of each person from the at least one computer system and implement the image data in a suitable format for viewing of the icons in various locations of the place by the prospective attendee from the remote location.

In certain embodiments, an application is configured to be synced from the website via a cellular, wired, or wireless network, wherein each person's image signature is downloaded to an electronic device such that the prospective attendee may view movement and/or position of the icons in various locations of the place from the electronic device.

In certain embodiments, the first location of the place is an entrance and/or an exit.

In certain embodiments, an additional infrared thermal imaging camera in the first location assigns an image signature to each person passing therethrough.

In certain embodiments, the captured image data from the first infrared thermal imaging camera includes metadata for identifying objects from the captured image data such that image data may be analyzed and objects may be searched and selected for each corresponding image signature by the prospective attendee from the remote location.

In certain embodiments, the at least one computer system is configured to enable the prospective attendee the capability to categorize, index, label, and sort the captured image data through recognition of contents of the image data, and to search and retrieve image data and/or each corresponding image signature for each person through text and/or image input.

In certain embodiments, the people counter system includes capability for tracking the number of people in the place as a whole and/or by gender.

In certain embodiments, the first infrared thermal imaging camera and the at least one optional infrared thermal imaging camera are configured to be implemented with a facial recognition system.

In certain embodiments, the first and second infrared thermal imaging cameras and the at least one optional infrared thermal imaging camera are configured to be implemented with a video camera.

In certain embodiments, the first and second infrared thermal imaging cameras and the at least one optional infrared thermal imaging camera are configured to be implemented with a global positioning system device for security and/or surveillance purposes.

In certain embodiments, the first and second infrared thermal imaging cameras and the at least one optional infrared thermal imaging camera are configured to be used for gender identification at live concerts, events, or shows.

In certain embodiments, the first and second infrared thermal imaging cameras and the at least one optional infrared thermal imaging camera include capability to record and/or stream live via the website and/or an application for an electronic device.

In certain embodiments, the at least one additional location of the at least one optional infrared thermal imaging camera is a multiple entrance/exit of the place for capturing image data of people passing therethrough in view of the at least one optional infrared thermal imaging camera.

In certain embodiments, the representative icon for each gender includes a uniform appearance and color.

In certain embodiments, the representative icon for each gender includes a geometric shape in blue for males and in pink for females.

In certain embodiments, the representative icon for each gender is a hologram.

In certain embodiments, the at least one microphone of the second infrared thermal imaging camera positioned in the second location includes capability to transmit live for at least one of bands, events, comedic performances, DJ, jukebox, karaoke, musical concerts, play list, poetry, shows, and the like.

In certain embodiments, the at least one computer system is in communication with an amplifier/audio system of the place for providing an enhanced quality of sound to the locations of the place when viewing movement and/or position of the icons for each gender from the remote location.

In certain embodiments, the corresponding still photograph background of the second location and the corresponding optional still photograph background of the at least one additional location is at least one of a bar, discotheque, entertainment venue, lounge, night club, restaurant, and the like.

In certain embodiments, the prospective attendee from the remote location may conduct at least one search of the place of entertainment, leisure and/or recreation through the website or an application for an electronic device comprising: within an inserted radius from less than a mile to worldwide; by neighborhood, city, county, state, country, continent and/or worldwide; number of total people ratio to maximum occupancy; most or least males; most or least females; highest or lowest ratio male to female; highest or lowest ratio female to male; type of entertainment, leisure and/or recreation venue; by favorite or any venue; music play list, genre, and/or band performers; live events; entertainment, leisure, and/or recreation venue amenities and/or specials; location of friends in network; latest posts by friends in network; and latest posts from favorite entertainment venues in network.

In a further aspect, there is provided herein a method for providing thermal gender recognition of people in any place of entertainment, leisure and/or recreation, to enable a prospective attendee determine in advance from a remote location where the prospective attendee would like to be. The method includes positioning a first infrared thermal imaging camera in a first location of the place for capturing image data of people passing therethrough, by which a body temperature of each person is obtained for calculating a person's gender, wherein the first infrared thermal imaging camera thereby assigns an image signature to each person. The method further includes implementing a people counter system in conjunction with the first infrared thermal imaging camera for concurrently counting each gender passing through the first location. A second infrared thermal imaging camera having at least one camera is positioned in a second location of the place, wherein the second infrared thermal imaging camera is configured to continue gender recognition and follow each person in view while showing movement and/or position of such persons in the form of a representative icon for each gender against a corresponding still photograph background of the second location for viewing movement and/or position of the icons in the second location. At least one optional infrared thermal imaging camera is positioned in at least one additional location, wherein the at least one optional infrared thermal imaging camera is configured to continue gender recognition and follow each person in view while showing movement and/or position of the icons for each gender against a corresponding optional still photograph background of the at least one additional location for viewing movement and/or position of the icons in the at least one additional location.

The method further includes providing at least one computer system capable of communicating with a server over a network for retrieval, processing, and transmission of the image data of each person in view of the first and second infrared thermal imaging cameras and the at least one optional infrared thermal imaging camera. A website is configured to receive the image data of each person from the at least one computer system and implement the image data in a suitable format for viewing of the icons in various locations of the place by the prospective attendee from the remote location. An application can be synced from the website via a cellular, wired, or wireless network, wherein each person's image signature is downloaded to an electronic device such that the prospective attendee may view movement and/or position of the icons in various locations of the place from the electronic device.

In certain embodiments, the first infrared thermal imaging camera and the at least one optional infrared thermal imaging camera are configured to be implemented with a facial recognition system.

Various advantages of this invention will become apparent to those skilled in the art from the following detailed description of the preferred embodiments, when read in light of the accompanying drawings.

### BRIEF DESCRIPTION OF THE DRAWINGS

FIG. 1 is an operational block diagram of an exemplary embodiment in accordance with one aspect of the present invention.

FIG. 2 is a flow process of an image data processing program executed by a computer system in conjunction with an infrared thermal imaging camera for providing thermal gender recognition in accordance with one aspect of the present invention.

FIG. 3 is an operational block diagram of an exemplary system for retrieval and processing of captured image data into representative icons for each gender in accordance with one aspect of the present invention.

FIG. 4 is an exemplary screen shot illustrating movement and/or position of the representative icons for each gender against a corresponding still photograph background of a location of the place in accordance with one aspect of the present invention.

FIG. 5 is an operational block diagram of an exemplary embodiment in accordance with another aspect of the present invention.

### DETAILED DESCRIPTION OF THE INVENTION

The detailed description set forth below in connection with the appended drawings is intended as a description of various and preferred embodiments of the present disclosure, and is not intended to represent the only forms that may be developed or utilized. The description sets forth the various functions in connection with the illustrated embodiments, but it is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

In consideration of the figures, it is to be understood for purposes of clarity certain details of construction and/or operation are not provided in view of such details being conventional and well within the skill of the art once the present invention is disclosed and described herein.

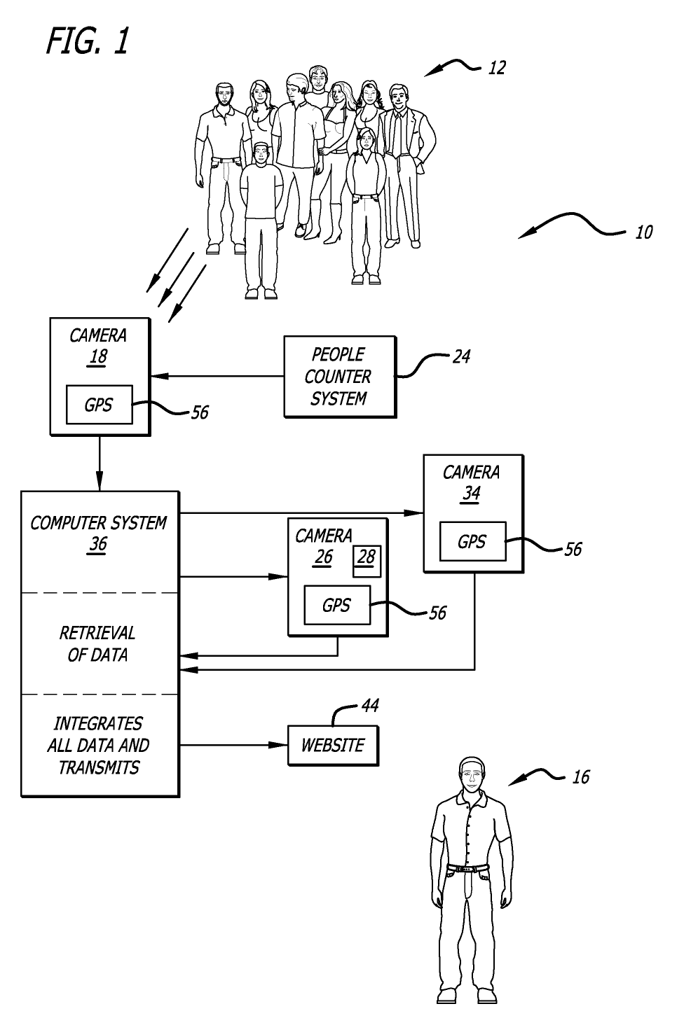

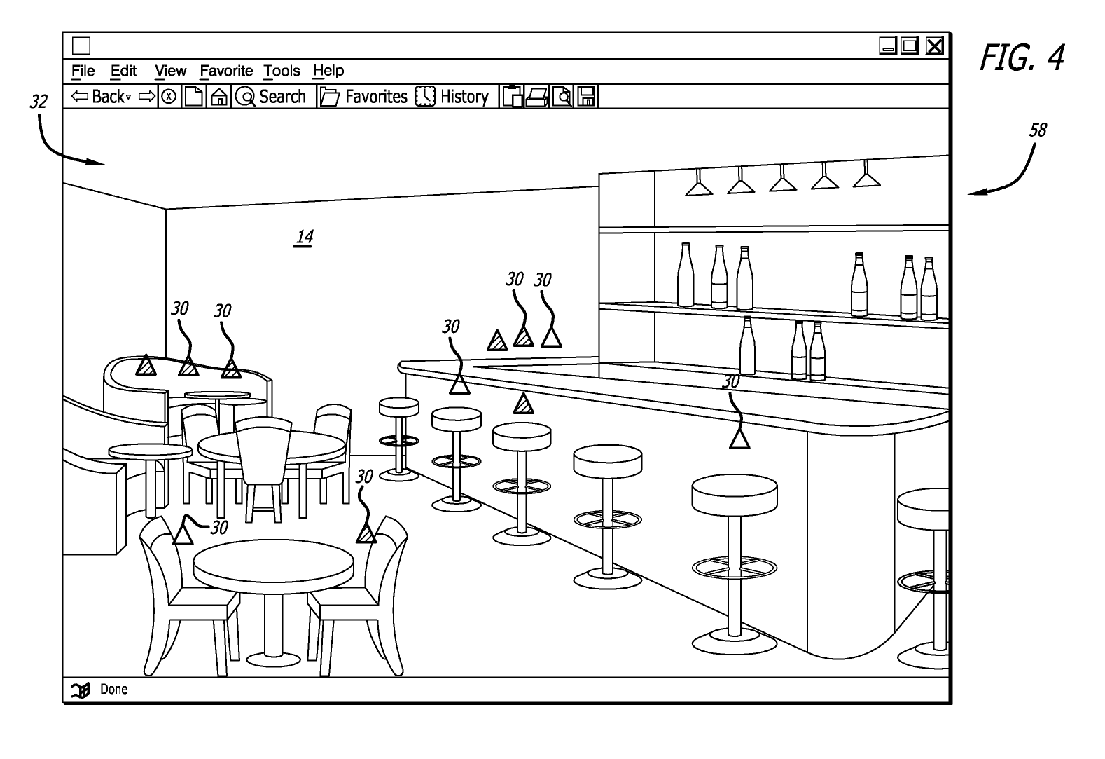

Referring now to FIG. 1, there is depicted a system 10 in the form of an operational block diagram for providing thermal gender recognition of people 12 in any place of entertainment, leisure and/or recreation 14 (FIG. 4), to enable a prospective attendee 16 determine in advance from a remote location where the prospective attendee would like to be. The system 10 includes a first infrared thermal imaging camera 18 positioned in a first location of the place 14 for capturing image data 20 of people 12 passing therethrough by which a body temperature of each person is obtained for calculating a person's gender, wherein the first infrared thermal imaging camera 18 thereby assigns an image signature 22 to each person.

A people counter system 24 can be configured to be implemented in conjunction with the first infrared thermal imaging camera 18 for concurrently counting people 12 and/or each gender passing through the first location of the place 14 (FIG. 4). In one embodiment, the people counter system 24 includes capability for tracking the number of people 12 in the place 14 as a whole and/or by gender at the first location. It is contemplated that the people counter system 24 used in accordance with the system 10 and method of the present invention can be configured to indicate the number of people (as well as other appropriate searches) that were in the place 14 from yesterday to a year ago and/or other select time frames. It is further contemplated that the people counter system 24 used in accordance with the system 10 and method of the present invention can indicate average crowd size as well as other desired searches, including, but not limited to, male to female ratio for a particular day over the past month and/or year, and the average male to female ratio of the prior week, month, and/or year. A people counter system of the type developed by Rhonda Software (Vladivostok, Russia) or other similar people counter system may be suitable for use with the system 10 and method of the present invention.

A second infrared thermal imaging camera 26 having at least one microphone 28 is positioned in a second location of the place 14 (FIG. 4). The second infrared thermal imaging camera 26 is configured to continue gender recognition and follow each person 12 in view while showing movement and/or position of such persons in the form of a representative icon 30 (FIG. 4) for each gender against a corresponding still photograph background of the second location 32 (FIG. 4) for viewing movement and/or position of the icons in the second location of the place 12 by the prospective attendee 16 from a remote location. It should be understood that the corresponding still photograph background of the second location 32 and of any additional locations (not shown) used in accordance with the present invention is an actual digital photograph initially taken without any persons in the location in order to capture the true integrity of the place 14.

In a preferred embodiment, the at least one microphone 28 of the second infrared thermal imaging camera 26 positioned in the second location 32 includes capability to transmit live for at least one of bands, events, comedic performances, DJ, jukebox, karaoke, musical concerts, play list, poetry, shows, and the like, in the place 14.

At least one optional infrared thermal imaging camera 34 can be positioned in at least one additional location (not shown) of the place 12. The at least one optional infrared thermal imaging camera 34 can be configured to continue gender recognition and follow each person 12 in view while showing movement and/or position of the icons 30 for each gender against a corresponding optional still photograph background of the at least one additional location (not shown) for viewing movement and/or position of the icons in the at least one additional location by the prospective attendee 16 from a remote location.

The system 10 and method of the present invention are suitable for use with infrared thermal imaging cameras and suitable infrared thermal imaging camera software of the type manufactured by FLIR Systems (Boston, Mass.) or similar conventional thermal imaging cameras and thermal imaging software. It is contemplated that such infrared thermal imaging cameras 18, 26, 34 or similar conventional thermal imaging cameras have full movement with the capability to rotate up and down and side-to-side, and within a range of various angles, while maintaining the true integrity of the background of the place 14 and capturing image data 20 of people 12 within the infrared thermal imaging cameras' respective fields of view. The infrared thermal imaging cameras 18, 26, 34 or similar conventional thermal imaging cameras used in accordance with the system 10 and method of the present invention may ride on an installed track system from the ceiling and/or walls of the place 14, providing a single infrared thermal imaging camera the ability to capture multiple spaces and/or rooms or simply a preferred vantage point at the time. Conventional infrared thermal imaging camera software or similar thermal imaging camera software operate in conjunction with infrared thermal imaging cameras or thermal imaging cameras for obtaining a body temperature of each person in the calculation of a person's respective gender. It is to be understood that the system 10 and method of the present invention may also use near-infrared (NIR), mid-infrared (MIR) and far-infrared (FIR) imaging cameras in the determination of a person's respective gender in accordance with the present invention. The following Table illustrates the various designations of infrared imaging that may be used in accordance with the present invention. Of these various infrared bands or regions, the thermal imaging region (LWIR) is preferred.

TABLE

| Designation | Abbreviation | Wavelength | |
|---|---|---|---|
| Near-Infrared | NIR | 0.78-3 | μm |
| Mid-Infrared | MIR | 3-50 | μm |
| Long-Wavelength Infrared | LWIR | 8-15 | μm |
| (thermal imaging region) | | | |
| Far-Infrared | FIR | 50-1000 | μm |

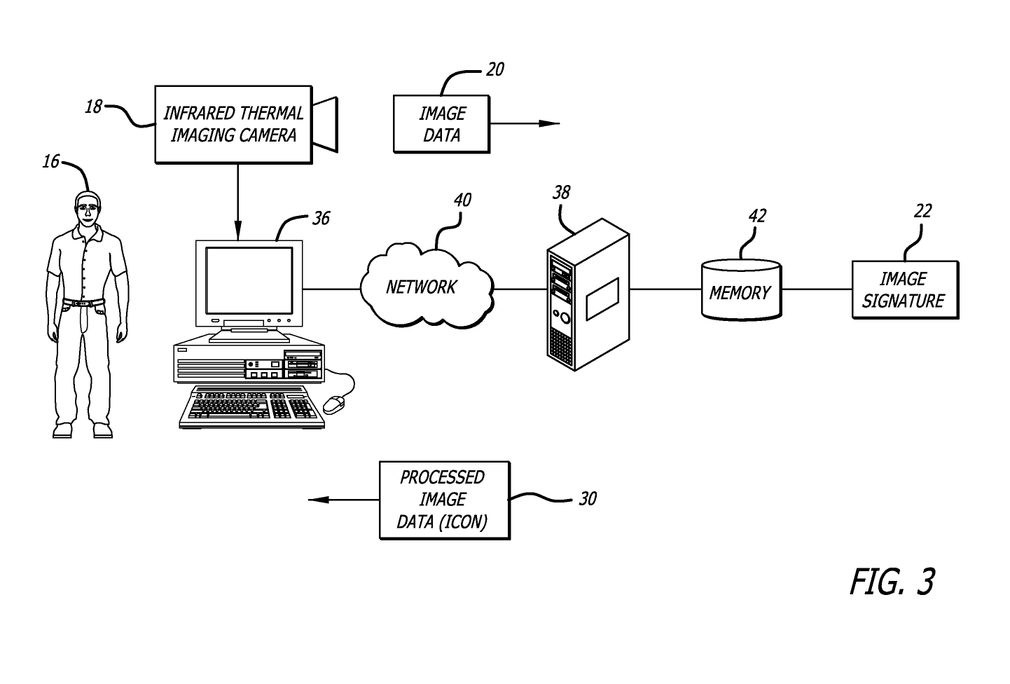

As shown in FIGS. 1 and 3, the system 10 in accordance with the present invention further includes at least one computer system 36 capable of communicating with a server 38 over a network 40 for retrieval, processing, and transmission of the image data 20 of each person 12 in view of the first and/or second infrared thermal imaging cameras 18, 26 and/or the at least one optional infrared thermal imaging camera 34. The at least one computer system 36 can be a personal computer or other computing device. Exemplary networks contemplated to be used in accordance with the present invention include Ethernet, Internet, or other suitable physical network infrastructure. It should be understood that the at least one computer system 36 can include multiple network interfaces and/or a network interface configured to interface with multiple networks in accordance with the present invention. The first and second infrared thermal imaging cameras 18, 26 and the at least one optional infrared thermal imaging camera 34 and the at least one computer system 36 can be configured to operate through Personal Area Networks (PAN) or Wireless Local Area Networks (WLAN) in accordance with the system 10 and method of the present invention. It is contemplated that the at least one computer system 36 can be configured to operate via Global System for Mobile Communications (GSM) or Worldwide Interoperability for Microwave Access (WiMAX) or similar technology in accordance with the system 10 and method of the present invention. It is further contemplated that the at least one computer system 36 can be configured to have satellite connection capability as well as wired/cable connection compatibility.

FIG. 3 is an operational block diagram of an exemplary system for retrieval and processing of captured image data 20 into representative icons 30 for each gender in accordance with the system 10 and method of the present invention. As shown in FIG. 3, the server 38 is in communication with a memory 42, which can store the image signature 22 from the image data 20 of each person 12 in the processing or conversion of the image data into a representative icon 30 for each gender. It should be understood that the server 38 can be a computing device configured to serve one or more computer systems in accordance with the system 10 and method of the present invention.

Referring further to FIG. 1, a website 44 is configured to receive the image data 20 of each person 12 from the at least one computer system 36 and implement the image data in a suitable format for viewing of the icons 30 in various locations of the place 14 (FIG. 4) by the prospective attendee 16 from a remote location.

In a preferred embodiment, an application 46 may be configured to be synced from the website 44 via a cellular, wired (e.g., Ethernet or Internet), or wireless (e.g., Bluetooth or Wi-Fi) network, such that each person's 12 image signature 22 is downloaded to an electronic device 48 so the prospective attendee 16 may view movement and/or position of the icons 30 in various locations of the place 14 from the electronic device. The electronic device 48 may be a cellular phone, personal digital assistant (PDA), smart phone, or a similar mobile or handheld device, used by the prospective attendee 16 from a remote location.

In one embodiment, the first location of the place 14 (FIG. 4) is an entrance and/or an exit. In another embodiment, the at least one optional infrared thermal imaging camera 34 can be positioned in at least one additional location (not shown), which is a multiple entrance and/or exit of the place 14, for capturing image data 20 of people 12 passing therethrough in view of the at least one optional infrared thermal imaging camera. It should be understood that the place 14 may have further multiple entrances and/or exits with additional infrared thermal imaging cameras positioned throughout various locations of the place.

In a further embodiment, an additional infrared thermal imaging camera (not shown) in the first location assigns an image signature 22 to each person 12 passing in the field of view of the additional infrared thermal imaging camera.

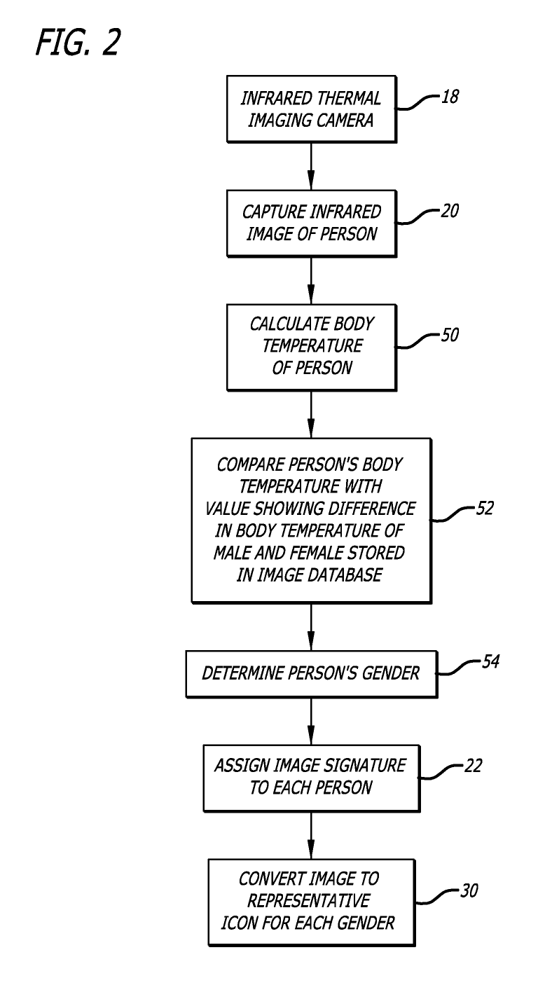

FIG. 2 is a flow process of an image data processing program executed by the at least one computer system 36 in conjunction with the first infrared thermal imaging camera 18 and/or any additional infrared thermal imaging cameras at multiple entrances and/or exits of the place 14 (FIG. 4) for providing thermal gender recognition in accordance with the system 10 and method of the present invention. Following capture of a person's image 20 in the field of view of the first infrared thermal imaging camera 18 in the first location of the place 14, the person's body temperature is calculated by the infrared thermal imaging software 50 in conjunction with the at least one computer system 36. For each person whose image has been captured by the first infrared thermal imaging camera 18, a comparison 52 of the person's body temperature is made with a reference value showing the difference in body temperature of males and females stored in an image database. Based on the results of the reference value comparison 52, each person's respective gender may be determined 54 according to conventional methods known in the art. An image signature 22 is assigned to each person 12 and is converted to a representative icon 30 for each gender as further shown in FIG. 3.

In one embodiment, the captured image data 20 from the first infrared thermal imaging camera 18 includes metadata for identifying objects from the captured image data such that image data may be analyzed and objects may be searched and selected for each corresponding image signature 22 by the prospective attendee 16 from a remote location. In another embodiment, the at least one computer system 36 can be configured to enable the prospective attendee 16 the capability to categorize, index, label, and sort the captured image data 20 through recognition of contents of the image data, and to search and retrieve image data and/or each corresponding image signature for each person 12 through text and/or image input. An exemplary objectified image rendering system of the type disclosed in U.S. Patent Publication No. US2011/0026853 filed Jun. 21, 2010, the content of which is incorporated herein in its entirety, or other similar objectified image rendering system may be suitable for use in conjunction with the system 10 and method of the present invention.

In yet another embodiment, the first infrared thermal imaging camera 18 and the at least one optional infrared thermal imaging camera 34 can be configured to be implemented with a facial recognition system (not shown), including facial recognition software, in the determination of a person's 12 gender in the place 14 (FIG. 4). It should be understood that the infrared thermal imaging cameras 18, 34 can be turned “off” while the facial recognition system is in use with the system 10 and/or the infrared thermal imaging cameras and the facial recognition system can operate simultaneously with each other. It is contemplated that a number of conventional facial recognition systems, including facial recognition software, manufactured by various companies may be suitable for use in conjunction with the system 10 and method of the present invention.

In another embodiment, the first and second infrared thermal imaging cameras 18, 26 and the at least one optional infrared thermal imaging camera 34 can be configured to be implemented with a standard video camera (not shown) in the determination of a person's gender in the place 14 (FIG. 4). It should be understood that the infrared thermal imaging cameras 18, 26, 34 can be turned “off” while the video camera (not shown) is in use with the system 10 and/or the infrared thermal imaging cameras and the video camera can operate simultaneously with each other. It is contemplated that a number of standard video cameras manufactured by various companies (e.g., Sony) and of a type used in machine vision systems may be suitable for use in conjunction with the system 10 and method of the present invention. It is further contemplated that such standard video camera includes focus, tilt, and zoom capabilities that allow rapid movement of the video camera throughout various locations of the place to obtain high quality face images from people passing in the field of view of the video camera.

In an exemplary embodiment, the first and second infrared thermal imaging cameras 18, 26 and the at least one optional infrared thermal imaging camera 34 can be configured to be implemented with a global positioning system (GPS) device 56 for security and/or surveillance purposes. As a loss prevention measure, a portable GPS device 56 can be installed on each of the infrared thermal imaging cameras 18, 26, 34 in such manner to permit later removal of the GPS device as necessary. It is contemplated that each of the infrared thermal imaging cameras 18, 26, 34 may be linked to a primary security system of the place 14 in which such primary security system would be triggered if there is any unauthorized movement of the infrared thermal imaging cameras of the system 10. A number of standard GPS devices manufactured by various companies may be suitable for use in conjunction with the system 10 and method of the present invention.

In a further embodiment, the first and second infrared thermal imaging cameras 18, 26 and the at least one optional infrared thermal imaging camera 34 can be configured to be used for gender identification of persons 12 at live concerts, events, or shows in accordance with the system 10 and method of the present invention. In another embodiment, the first and second infrared thermal imaging cameras 18, 26 and the at least one optional infrared thermal imaging camera 34 include capability to record and/or stream live via the website 44 and/or an application 46 for an electronic device 48.

FIG. 4 is an exemplary screen shot 58 illustrating movement and/or position of the representative icons 30 for each gender against a corresponding still photograph background of the second location 32 or at least one additional location of the place 14 in accordance with the system 10 and method of the present invention. In a preferred embodiment, the representative icon 30 for each gender includes a uniform appearance and color. The representative icon 30 preferably includes a geometric shape (e.g., triangle) in blue (shown as cross-hatching in FIG. 4) for males and in pink (shown without cross-hatching in FIG. 4) for females. It should be understood that other geometric shapes and colors and/or shading may be used for the representative icon 30 for each gender in accordance with the system 10 and method of the present invention.

In an alternative embodiment, the representative icon 30 for each gender can be a hologram (not shown) and/or other similar three-dimensional icon captured on a two-dimensional surface.

In a preferred embodiment, the corresponding still photograph background of the second location 32 and/or the corresponding optional still photograph background of the at least one additional location (not shown) is at least one of a bar, entertainment venue, lounge, night club, restaurant, and the like.

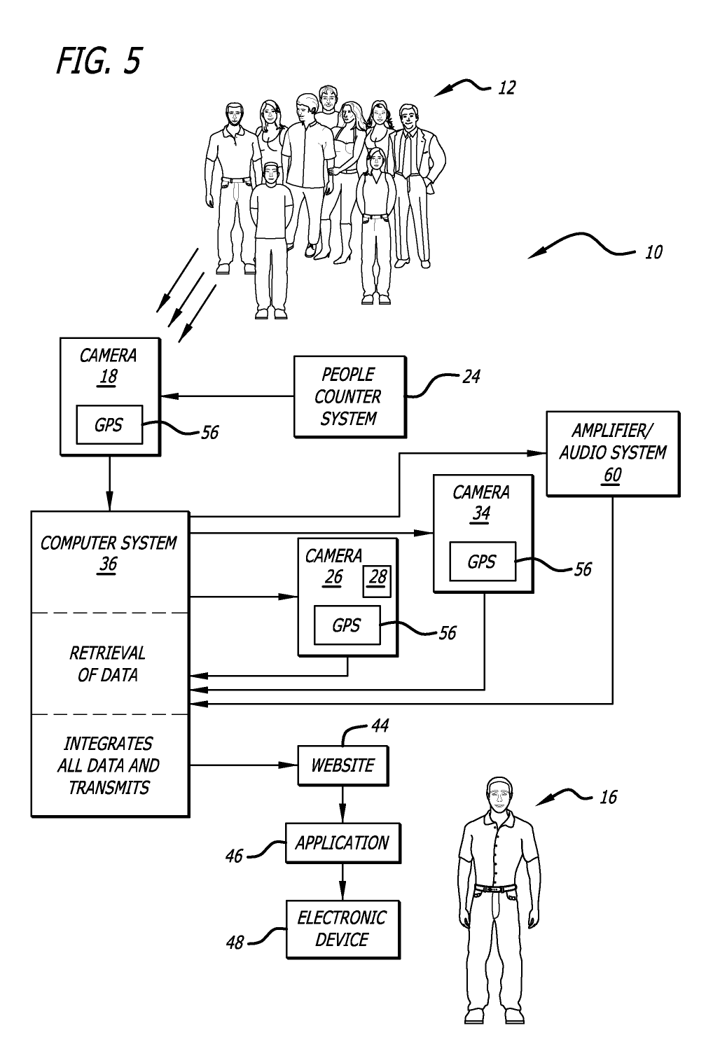

FIG. 5 is an operational block diagram of an exemplary embodiment in accordance with the present invention. In this embodiment, the system 10 is shown having an application 46 configured to be synced from the website 44 via a cellular, wired (e.g., Ethernet or Internet), or wireless (e.g., Bluetooth or Wi-Fi) network, such that each person's 12 image signature 22 is downloaded to an electronic device 48 so the prospective attendee 16 may view movement and/or position of the icons 30 in various locations of the place 14 from the electronic device. The electronic device 48 may be a cellular phone, personal digital assistant (PDA), smart phone, or a similar mobile or handheld device, used by the prospective attendee 16 from a remote location.

In a further embodiment, the at least one computer system 36 is in communication with an amplifier/audio system 60 of the place 14 for providing an enhanced quality of sound to the various locations when viewing movement and/or position of the icons 30 for each gender by the prospective attendee 16 from a remote location. The amplifier/audio system 60 of the place 14 can be configured to be implemented with the at least one computer system 36 according to conventional methods known in the art.

In yet another embodiment, the prospective attendee 16 from the remote location may conduct at least one search of the place of entertainment, leisure and/or recreation 14 through the website 44 or an application 46 for an electronic device 48 in accordance with the system 10 of the present invention, including as follows: within an inserted radius from less than a mile to worldwide; by neighborhood, city, county, state, country, continent and/or worldwide; number of total people ratio to maximum occupancy; most or least males; most or least females; highest or lowest ratio male to female; highest or lowest ratio female to male; type of entertainment, leisure and/or recreation venue (e.g., bars, clubs, lounges, nightclubs); by favorite or any venue; music play list, genre, and/or band performers; live events; entertainment, leisure, and/or recreation venue amenities (e.g., scenic rooftops, spacious dance floors) and/or specials (e.g., happy hour, specials of the day/week/month); location of friends in network; latest posts by friends in network; and latest posts from favorite entertainment venues in network.

Additional desirable features of the system 10 in accordance with the present invention include capability for owner(s)/management of each place 14 to access their own respective sub-sites of the network 40 having live monitoring systems via the at least one computer system 36 and revise or update information content as such owner(s)/management see fit. Exemplary of such information content that may be revised or updated include as follows: calendar events, live audio with or without song list, drink or other specials, dress code, acceptance of reservations, floor plans/virtual tour of place, and the like. It is contemplated that owner(s)/management can interact with prospective attendees 16 and/or patrons via a conventional social network. Prospective attendees 16 and/or patrons will also have capability via navigation/GPS technology to share their respective locations with others.

It is also contemplated that the owner(s)/management can control the lighting and heating, ventilating, and air conditioning (HVAC) systems of the place through the system 10 of the present invention. The system 10 can also be configured to be connected with the fire/sprinkler system of the place such that the system can alert the appropriate authorities in the event of an emergency.

It is further contemplated that when owner(s)/management sub-site of the network 40 is turned “off” prior to opening or closing time of the place to the public, but remained “on” for the owner(s)/management, each such owner(s)/management can monitor their respective sub-site through use of an exclusive access code/password. The sub-site live monitoring system can also include capability to operate as a security system triggered by motion of people in view of the infrared thermal imaging cameras at all entrances and/or exits once such system has been activated. This security system feature could be activated or deactivated via the owner(s)/management sub-site by either a timer or by entry of a code using an exclusive access/password.

An additional desirable feature of the system 10 of the present invention enables the owner(s)/management and/or doormen of the place to access via a clearance code from any electronic device the sub-site live monitoring system to monitor and track the number of males and females entering and exiting the place detected by the people counter system.

It is further contemplated that the prospective attendee 16 from the remote location can participate in various activities via the system 10 of the present invention. Non-limiting examples of such activities include as follows: select and purchase jukebox songs, sign up for karaoke, submit request to playlist, participate in karaoke, trivia games, bingo, and other such social games, place orders to seat/table, and the like.

The system 10 can be further configured to contain a database index of known media (e.g., music) files in which an unknown media sample can be identified with a matching media file in the database. In addition, the system 10 can be configured to identify and display what song and/or other audio recording is currently being played and/or previously played within a certain time frame at the place via the website 44 and/or the application 46 for access by the prospective attendee 16 from a remote location and/or an electronic device 48, respectively. It is further contemplated that once the song and/or other audio recording are identified to the prospective attendee 16, the prospective attendee 16 may perform transactions interactively in either real-time or off-line using the identification information in accordance with the system 10 of the present invention. Sound recognition in conjunction with the system 10 of the present invention may be conducted according to conventional methods and systems for identifying pre-recorded sounds and/or other audio signals in nearly any environment.

It is to be understood that the system 10 of the present invention is not limited to the embodiments shown in FIGS. 1 and 5, but rather the system is capable of being uniquely tailored to suit the particular place 14. For example, a large place having greater square footage in area than a small place may require additional infrared thermal imaging cameras and/or amplifier/audio system implements and the like in order to adequately cover the various locations throughout the place. In addition, the system 10 may require more than one computer system in order to accommodate any additional infrared thermal imaging cameras and/or amplifier/audio system implements and the like in the various locations throughout the place.

In a further aspect of the present invention, there is provided herein a method for providing thermal gender recognition of people in any place of entertainment, leisure and/or recreation, to enable a prospective attendee determine in advance from a remote location where the prospective attendee would like to be. The method includes positioning a first infrared thermal imaging camera in a first location of the place for capturing image data of people passing therethrough, by which a body temperature of each person is obtained for calculating a person's gender, wherein the first infrared thermal imaging camera thereby assigns an image signature to each person. The method further includes implementing a people counter system in conjunction with the first infrared thermal imaging camera for concurrently counting each gender passing through the first location. A second infrared thermal imaging camera having at least one camera is positioned in a second location of the place, such that the second infrared thermal imaging camera is configured to continue gender recognition and follow each person in view while showing movement and/or position of such persons in the form of a representative icon for each gender against a corresponding still photograph background of the second location for viewing movement and/or position of the icons in the second location. At least one optional infrared thermal imaging camera is positioned in at least one additional location, wherein the at least one optional infrared thermal imaging camera is configured to continue gender recognition and follow each person in view while showing movement and/or position of the icons for each gender against a corresponding optional still photograph background of the at least one additional location for viewing movement and/or position of the icons in the at least one additional location.

The method further includes providing at least one computer system capable of communicating with a server over a network for retrieval, processing, and transmission of the image data of each person in view of the first and second infrared thermal imaging cameras and the at least one optional infrared thermal imaging camera. A website is configured to receive the image data of each person from the at least one computer system and implement the image data in a suitable format for viewing of the icons in various locations of the place by the prospective attendee from the remote location. An application can be synced from the website via a cellular, wired, or wireless network, wherein each person's image signature is downloaded to an electronic device such that the prospective attendee may view movement and/or position of the icons in various locations of the place from the electronic device.

In one embodiment, the first infrared thermal imaging camera and the at least one optional infrared thermal imaging camera are configured to be implemented with a facial recognition system.

While the invention has been described with reference to the preferred embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiments disclosed herein contemplated for carrying out this invention, but that the invention will include all embodiments falling within the scope of the claims.

What is claimed is:

1. A system for providing thermal gender recognition of people in any place of entertainment, leisure and/or recreation, to enable a prospective attendee determine in advance from a remote location where the prospective attendee would like to be, the system comprising:
a first infrared thermal imaging camera positioned in a first location of the place for capturing image data of people passing therethrough by which a body temperature of each person is obtained for calculating a person's gender, wherein the first infrared thermal imaging camera thereby assigns an image signature to each person;
a people counter system configured to be implemented in conjunction with the first infrared thermal imaging camera for concurrently counting each gender passing through the first location;
a second infrared thermal imaging camera positioned in a second location of the place and having at least one microphone, configured to continue gender recognition and follow each person in view while showing movement and/or position of such persons in the form of a representative icon for each gender against a corresponding still photograph background of the second location for viewing movement and/or position of the icons in the second location;
at least one optional infrared thermal imaging camera positioned in at least one additional location, configured to continue gender recognition and follow each person in view while showing movement and/or position of the icons for each gender against a corresponding optional still photograph background of the at least one additional location for viewing movement and/or position of the icons in the at least one additional location;
at least one computer system capable of communicating with a server over a network for retrieval, processing, and transmission of the image data of each person in view of the first and second infrared thermal imaging cameras and the at least one optional infrared thermal imaging camera; and
a website configured to receive the image data of each person from the at least one computer system and implement the image data in a suitable format for viewing of the icons in various locations of the place by the prospective attendee from the remote location.

2. The system of claim 1, further comprising an application configured to be synced from the website via a cellular, wired, or wireless network, wherein each person's image signature is downloaded to an electronic device such that the prospective attendee may view movement and/or position of the icons in various locations of the place from the electronic device.

3. The system of claim 1, wherein the first location of the place is an entrance and/or an exit.

4. The system of claim 1, wherein an additional infrared thermal imaging camera in the first location assigns an image signature to each person passing therethrough.

5. The system of claim 1, wherein the captured image data from the first infrared thermal imaging camera includes metadata for identifying objects from the captured image data such that image data may be analyzed and objects may be searched and selected for each corresponding image signature by the prospective attendee from the remote location.

6. The system of claim 1, wherein the at least one computer system is configured to enable the prospective attendee the capability to categorize, index, label, and sort the captured image data through recognition of contents of the image data, and to search and retrieve image data and/or each corresponding image signature for each person through text and/or image input.

7. The system of claim 1, wherein the people counter system includes capability for tracking the number of people in the place as a whole and/or by gender.

8. The system of claim 1, wherein the first infrared thermal imaging camera and the at least one optional infrared thermal imaging camera are configured to be implemented with a facial recognition system.

9. The system of claim 1, wherein the first and second infrared thermal imaging cameras and the at least one optional infrared thermal imaging camera are configured to be implemented with a video camera.

10. The system of claim 1, wherein the first and second infrared thermal imaging cameras and the at least one optional infrared thermal imaging camera are configured to be implemented with a global positioning system device for security and/or surveillance purposes.

11. The system of claim 1, wherein the first and second infrared thermal imaging cameras and the at least one optional infrared thermal imaging camera are configured to be used for gender identification at live concerts, events, or shows.

12. The system of claim 1, wherein the first and second infrared thermal imaging cameras and the at least one optional infrared thermal imaging camera include capability to record and/or stream live via the website and/or an application for an electronic device.

13. The system of claim 1, wherein the at least one additional location of the at least one optional infrared thermal imaging camera is a multiple entrance/exit of the place for capturing image data of people passing therethrough in view the at least one optional infrared thermal imaging camera.

14. The system of claim 1, wherein the representative icon for each gender comprises a uniform appearance and color.

15. The system of claim 1, wherein the representative icon for each gender comprises a geometric shape in blue for males and in pink for females.

16. The system of claim 1, wherein the representative icon for each gender is a hologram.

17. The system of claim 1, wherein the at least one microphone of the second infrared thermal imaging camera positioned in the second location includes capability to transmit live for at least one of bands, events, comedic performances, DJ, jukebox, karaoke, musical concerts, play list, poetry, shows, and the like.

18. The system of claim 1, wherein the at least one computer system is in communication with an amplifier/audio system of the place for providing an enhanced quality of sound to the locations of the place when viewing movement and/or position of the icons for each gender from the remote location.

19. The system of claim 1, wherein the corresponding still photograph background of the second location and the corresponding optional still photograph background of the at least one additional location is at least one of a bar, discotheque, entertainment venue, lounge, night club, restaurant, and the like.

20. The system of claim 1, wherein the prospective attendee from the remote location may conduct at least one search of the place of entertainment, leisure and/or recreation through the website or an application for an electronic device comprising: within an inserted radius from less than a mile to worldwide; by neighborhood, city, county, state, country, continent and/or worldwide; number of total people ratio to maximum occupancy; most or least males; most or least females; highest or lowest ratio male to female; highest or lowest ratio female to male; type of entertainment, leisure and/or recreation venue; by favorite or any venue; music play list, genre, and/or band performers; live events; entertainment, leisure, and/or recreation venue amenities and/or specials; location of friends in network; latest posts by friends in network; and latest posts from favorite entertainment venues in network.

21. A method for providing thermal gender recognition of people in any place of entertainment, leisure and/or recreation, to enable a prospective attendee determine in advance from a remote location where the prospective attendee would like to be, the method comprising:
positioning a first infrared thermal imaging camera in a first location of the place for capturing image data of people passing therethrough by which a body temperature of each person is obtained for calculating a person's gender, wherein the first infrared thermal imaging camera thereby assigns an image signature to each person;
implementing a people counter system in conjunction with the first infrared thermal imaging camera for concurrently counting each gender passing through the first location;
positioning a second infrared thermal imaging camera in a second location of the place and having at least one microphone, wherein the second infrared thermal imaging camera is configured to continue gender recognition and follow each person in view while showing movement and/or position of such persons in the form of a representative icon for each gender against a corresponding still photograph background of the second location for viewing movement and/or position of the icons in the second location;
positioning at least one optional infrared thermal imaging camera in at least one additional location, wherein the at least one optional infrared thermal imaging camera is configured to continue gender recognition and follow each person in view while showing movement and/or position of the icons for each gender against a corresponding optional still photograph background of the at least one additional location for viewing movement and/or position of the icons in the at least one additional location;
providing at least one computer system capable of communicating with a server over a network for retrieval, processing, and transmission of the image data of each person in view of the first and second infrared thermal imaging cameras and the at least one optional infrared thermal imaging camera;
configuring a website to receive the image data of each person from the at least one computer system and implement the image data in a suitable format for viewing of the icons in various locations of the place by the prospective attendee from the remote location; and
syncing an application from the website via a cellular, wired, or wireless network, wherein each person's image signature is downloaded to an electronic device such that the prospective attendee may view movement and/or position of the icons in various locations of the place from the electronic device.

22. The method of claim 21, wherein the first infrared thermal imaging camera and the at least one optional infrared thermal imaging camera are configured to be implemented with a facial recognition system.
